(19) United States
(12) Patent Application Publication
(10) Pub. No.: US 2011/0151078 A1
(43) Pub. Date: Jun. 23, 2011

(54) Method for osmotically dewatering a cut fruit

(76) Inventor: Richard R. Dibbert, Yakima, WA (US)

(21) Appl. No.: 12/655,084

(22) Filed: Dec. 23, 2009

(51) Int. Cl. A23B 7/08; A23B 7/022

(52) U.S. Cl. 426/310; 426/640

(57) ABSTRACT

A method and composition for osmotically dewatering a freshly cut fruit product and optionally infusing the fruit product to improve or alter the sensory characteristic of the fruit, particularly when the fruit is a pome fruit variety, such as an apple or pear. The dewatering composition can be used by the consumer or food service person to prepare ready to eat fresh-cut fruit slices that exhibit improved or unexpected sensory characteristics comprising a mixture of xylitol, dextrose, natural or organic flavoring agent and optionally, citric acid, ascorbic acid, or enzyme, and optionally infusing the fresh-cut fruit by treating the fruit with the dewatering composition directly applied to the cut surface, or by dipping the cut surface into the composition.

### TECHNICAL FIELD

The invention relates to a method for using a composition that includes a novel use of a known organic compound with a freshly cut fruit food product. Specifically, the composition is employed to de-water the food product osmotically, which is most preferably a parenchyma cell based pome fruit, like an apple or pear. The composition may be used in concert with other compounds to improve or impart a flavor to the freshly cut fruit food product, and so may be adapted to be used as a seasoning, flavoring, acidulant, condiment, or flavor enhancer.

### BACKGROUND OF THE INVENTION

Parenchyma cells, as found in apples, are bathed in a water matrix and conduct most of their reactions in this watery fluid—a solution in which water is the solvent and the numerous molecules and ions dissolved in it are the solutes. The solutes include protons (H⁺), ions like sodium (Na⁺), potassium (K⁺), calcium (Ca²⁺), organic molecules such as sucrose (C₁₂H₂₂O₁₁), polar and nonpolar molecules, and a host of other substances; the chemical nature of which determines the ease or difficulty with which they move across cellular membranes.

All molecules possess kinetic energy and move in a random fashion. In solutions, solutes become distributed uniformly as they diffuse throughout the solution. Diffusion is the net movement of a substance from a region of higher concentration to a region of lower concentration, as a result of the random movement of its individual molecules; or, in other terms, down a concentration gradient. The greater or steeper the concentration gradient, the faster the movement of molecules across the gradient. If nothing intervenes in this process, the diffusion will continue until the concentration gradient is eliminated, and the substance is uniformly distributed. Most movement of materials in cells is by diffusion, although diffusion is neither the most time efficient means for molecular transport, nor can it effectively be relied upon for migrations over great distances.

Osmosis is a special kind of diffusion that pertains specifically to water. Commonly, osmosis is defined as the movement of water across a selectively permeable membrane, which permits the passage of water but inhibits the movement of the solute. The water transports down a combination concentration and pressure gradients from the region of its higher concentration of free, un-solvated water molecules (less solutes), to the region of its lower concentration of free water molecules (more solutes), with the possible added motive force of high pressure to low pressure across the membrane.

In osmosis, water moves from a hypotonic solution to a hypertonic through a selectively permeable membrane. Water will diffuse across a selectively permeable membrane until the concentrations are the same on both sides. If pressure is applied to the hypertonic side, it is possible to stop the inward flow of water. The amount of pressure needed to do so, is called the osmotic pressure of the solution and is proportional to the concentration of total solutes in the solution. Osmosis doesn't depend on the kinds of molecules or ions in solution, only on the relative concentration of solutes.

Commercially, osmotic dewatering is employed as a method of concentrating fruits and vegetables prior to air drying, freeze drying, or freezing where part of the natural water content of the fruit or vegetable is removed by immersing the materials in aqueous solutions of osmotic agents. For food products, typical osmotic agents are lactose, maltodextrin, ethanol, glucose, sucrose, and corn syrup.

Current commercial techniques aim to dehydrate food products by immersing them in a hypertonic solution. Water is removed, due to the difference of osmotic potential between the food and the osmotic solution, thereby reducing the water activity of the food and consequently the water available for chemical and biological deterioration.

One of the more commonly used osmotic agents employed is sucrose. It is also widely used as a food sweetener. It is used for its well known sweetening properties and also for bulking purposes. Although a wide variety of alternate osmotic agents are available, sucrose is generally considered to be an optimal choice.

Osmotic dewatering is an important process in the commercial food industry, which enable a food processor to remove various levels of water from the given food product as well as modify the chemical composition of the material. A simultaneous countercurrent transfer process is established in which water outflows to the surrounding solution, thus allowing the solute to infuse into the product.

The extraction of water from plant tissue is a complex product of numerous processes, going on both simultaneously and in a sequence. Plant tissues like the parenchyma cells found in pome fruits, are a capillary-porous body of liquid and gas in a solid matrix. The matrix forms a continuous and nonspatial whole, capable of transporting water and small molecules. The interconnected spaces form pathways, which exhibit capillary suction potential. Apple tissue subjected to osmotic dehydration draws a hypertonic solute into these intercellular spaces. Cells surrounding intercellular spaces shrink, which deforms the solid matrix while the connected intercellular spaces increase in size. Decreased external pressure further increases the drawing suction of the hypertonic solute.

Cells on the cut surface of the material undergoing osmotic dehydration are fully plasmolyzed over time, while those in the interior spaces can be in full turgor. Therefore, during osmotic dehydration a gradient of turgor pressure is developed, which can deform structure. Prior research suggests that full plasmolysis of cells is needed for expansion of intercellular spaces. The turgor pressure gradient appears to hinder the increase of intercellular spaces and thus water flow is caused mainly by the difference in pressure.

The following is a disclosure of the present invention that will be understood by reference to the following detailed description taken in conjunction with the accompanying drawings.

### BRIEF DESCRIPTION OF DRAWINGS

FIG. 1 is a graphical representation of experimental results, according to an embodiment of the invention;

FIG. 2 is a graphical representation of experimental results, according to an embodiment of the invention;

FIG. 3 is a graphical representation of experimental results, according to an embodiment of the invention; and

FIG. 4 is a graphical representation of experimental results, according to an embodiment of the invention.

Reference characters included in the above drawings indicate corresponding parts throughout the several charts and tables, as discussed herein. The description herein illustrates one preferred embodiment of the invention, in one form, and the description herein is not to be construed as limiting the scope of the invention in any manner. It should be understood that the above listed charts or figures are not necessarily to scale, and details that are not necessary for an understanding of the present invention by one skilled in the technology of the invention, or render other details difficult to perceive, may have been omitted.

### DETAILED DESCRIPTION OF SPECIFIC EMBODIMENTS

The present invention provides a composition including a novel combination of known organic compounds, for use with a freshly cut pome fruit food product. An original objective of the invention was to develop a complementary product that could be sold for end consumer or food service use to improve or alter the sensory characteristics of fresh-cut pome fruits. The intention was to develop a product that could infuse fresh-cut pome fruit surfaces with organic and/or natural compounds.

The present invention employs xylitol, which is a white crystalline substance that looks and tastes like sugar. On food labels, xylitol is classified broadly as a carbohydrate and more narrowly as a “polyol.” With more than twenty-five years of testing in widely different conditions, scientists have confirmed that xylitol is the best sweetener for teeth. Studies using xylitol as either a sugar substitute or a small dietary addition, have demonstrated a dramatic reduction in new tooth decay, along with arrest and even some reversal of existing dental caries. The human body naturally synthesizes xylitol, and produces up to fifteen grams of xylitol from food sources, using established chemical pathways. Xylitol is widely distributed throughout nature in small amounts. Some of the best sources are fruits, berries, mushrooms lettuce, hardwoods, and corncobs. Current scientific research on the material generally consists of uses in food as a sweetening agent, and in hygienic products. No substantive research was available, regarding the effects of xylitol used as an osmotic agent, and initially, xylitol was chosen as a sweetening agent in the present composition, only by chance. Subsequently, after several experimental trials, it was discovered that when xylitol was included in the composition, sensory enhancement of the fresh-cut pieces significantly improved, as compared to sucrose, the conventional sweetener.

Consequently, the present research shifted to investigate the effect of using xylitol as an osmotic agent, with a goal of an improved triggering of dewatering, and subsequently an infusion into fresh-cut pome tissue, thereby producing a fresh fruit product with enhanced sensorial characteristics. The resulting invention is a novel composition that can produce a rapid osmotic dewatering reaction on the cut surface of parenchyma cells, as found in pome fruits, in such a way as to deliver the desired solute solution into the intercellular spaces of the fruit, so that the end consumer can create the sensory enhanced or unexpectedly altered product. More particularly, the novel composition can be constructed to produce the unexpected sensory experience of sourness, on fruits naturally expected to be sweet. It can also produce a sensory experience typical of other fruit, which produces an unexpected sensory experience when combined with the texture of parenchyma cells, as found in pome fruits.

The commercially employed technique of using a 60% to 70% by weight aqueous sucrose solution for the osmotic dehydration of pome fruit tissue is well known. Additionally, the results of research relating to sucrose solution in osmotic dehydration processes are widely published and well known by those skilled in this technology. Therefore, it is well known that high concentrates of sucrose solution can create an osmotic dewatering of the material resulting in an increased dry matter content and reduced water concentration. Most commercial applications of the technique require an extended time-line in order to create the desired results in the material. It is common to treat cut fruit pieces in solute solution for up to twenty-four hours, in order to create the desired reduction of intercellular water levels.

A preferred method for osmotically dewatering a freshly cut fruit piece employing a xylitol material, includes applying the xylitol to a cut surface portion of the fruit piece, as a primary step. Initially, the fruit, which is preferably a pome fruit and most preferably an apple, may be cut or sliced by any method, as well known to fruit processors. The cut fruit piece can broadly referred to herein as a “slice,” the term intended to also include a cube, ring, wedge, stick, or any other cut form, as again known to those skilled in fruit processing. High-speed cutting systems, employing cutting tools and methods that minimize cell injury at the cut surface, are most preferred.

After cutting or slicing the apple, the cut surface portion of the apple piece is treated with the xylitol, preferably by distributing a pure powdered form of the xylitol onto the cut surface of the apple. Instead of manually or mechanically immersing the cut surface into a shallow vat or tray containing the pure powdered or granulated xylitol, a shaking or vibrating sieve can be employed, positioned above the cut slices, to distribute the xylitol onto the slices. With the overhead distribution onto the cut slices, any xylitol not contacting and adhering to the slice can be collected for recycled distribution, back to the overhead sieve.

As an less preferred alternative to the pure powdered xylitol, a saturated or near saturated solution of xylitol can be employed. The xylitol solution can be less concentrated that the conventional, commercially employed concentration for sucrose. Specifically, a 45% to 60% weight-to-weight, xylitol to water solution can be utilized for the osmotic dehydration of apple slices. However, the desiccating or initial drying properties of the xylitol will be reduced by this pre-dissolving of the xylitol into solution.

After treatment of the apple with the xylitol, the cut surface portion is exposed to air for a curing period. From experiments performed and the results detailed herein, the length of the curing period is preferably at least 30 minutes. A curing period of between 20 minutes and 60 minutes may be utilized, and factors such as humidity, temperature, and apple variety and ripeness may slightly influence the selected optimal curing period length.

During the curing period, a surface solution forms on the cut surface portion of the apple piece. The surface solution is referred to as “excess,” in that it flows freely and is not bound to the cut portion of the apple slice. The surface solution is primarily water, with small quantities of unabsorbed xylitol, and some dissolved salts and related ions as naturally present in the apple. Preferably, the excess surface solution is removed from the cut surface portion of the apple piece by simply placing each apple slice on a vibrating grate or mesh. Additionally, an absorbent material may be employed to contact with the cut surface, and more completely “wick” away the excess surface solution from the apple slices.

After removal of the excess surface solution, the apple pieces can be packaged in conventional, watertight containers. The container should be leak-tight and selected for low water permeability, but can allow the certain gasses to permeate, especially those generated by ripening fruit, as is known in the field of fresh produce packaging. The apple should be stored at a lower initial temperature, prior to display or transport. Storing the apple piece after packaging at a temperature between 31 degrees F. and 50 degrees F. will prolong storage life.

The novel composition of this invention achieves the desired results in less than thirty minutes, additionally it can be used by a consumer or food service person produce the product in their environment, not at a factory. The advantage is a product that is wholly fresh, not processed and readily consumable by the consumer.

### Example 1

Four apples of the “Fuji” variety were purchased from a local grocery store, and kept refrigerated until use. The apples were of similar size and maturity. Apple slices were produced by cross-sectionally cutting the fruit without removing the skin, so that only the cut surfaces were available for the mass transport. Two experimental series identified by two numbers (initial slice thickness and osmotic agent) were carried out at 20 degrees C., with two different sample thicknesses of 5 mm and 10 mm. The quantity of osmotic dewatering was measured for each slice, at elapsed time intervals of 0, 15, 30, and 60 minutes. Two osmotic agents were used in the series, commercially available sucrose and xylitol, both food grade materials at full and uncut strength, and approximately 99% pure. The term “approximately” is employed herein throughout, including this detailed description and the attached claims, with the understanding that is denotes a level of exactitude commensurate with the skill and precision typical for the particular field of endeavor, as applicable.

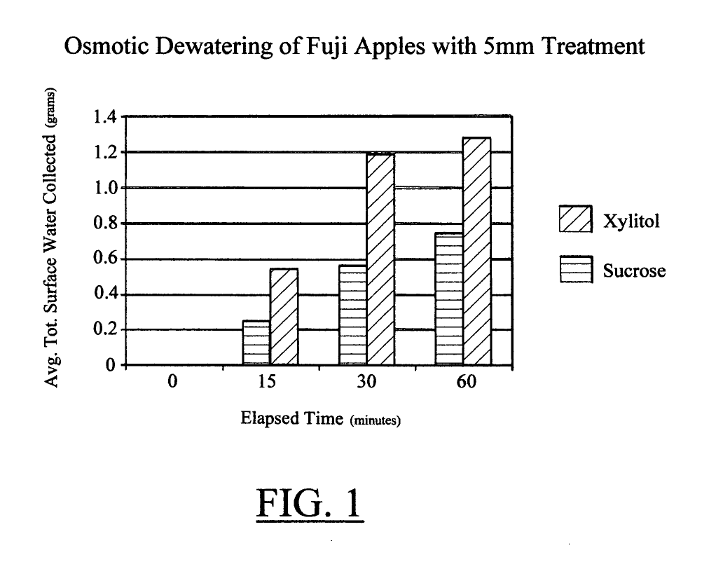

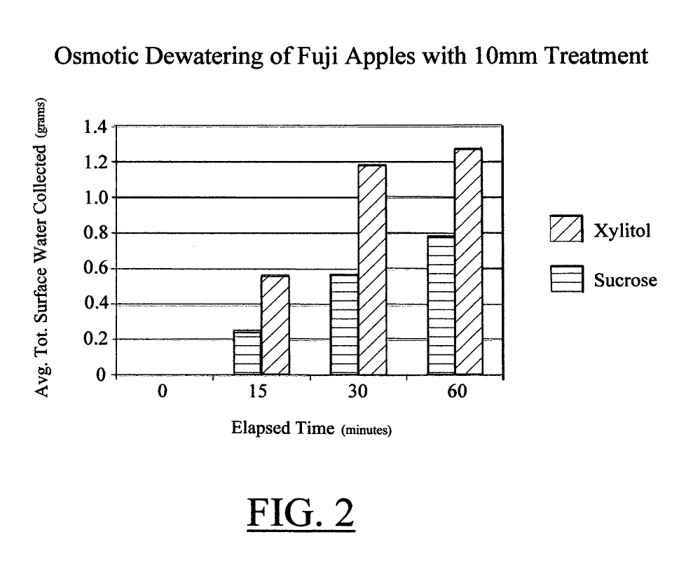

For this experimental example, the sucrose and xylitol osmotic agents were both milled to the same consistency. The slices were divided into series, each slice was weighed, and the osmotic agent in powder form was applied directly to the cut surface. Equal quantities of sucrose powder at 0.593 grams of the pure sucrose powder was applied to each slice for each sucrose series as listed in Tables 1A and 1B, and 0.593 grams of the pure xylitol powder was applied to each slice in each xylitol series, as listed in Tables 1C and 1D. The systems for each series were maintained at the selected temperature for the duration of the experiment. After the treatment, the surface water on each apple slice was collected and weighed, after which the slice was again weighed. The accumulated weight of water collected tabulated below, with the results of Table 1A correlated to the results of Table 1C in FIG. 1, and the results of Table 1B correlated to the results of Table 1D in FIG. 2. From FIGS. 1 and 2, the unexpected advantage of xylitol as a dewatering agent over sucrose, for use with Fuji variety apples is readily apparent.

TABLE 1A
Fuji Apples - 5 Slices Treated with Sucrose
5 mm Apple Slice

| | Cumulative Weight of Water | | | | |
|---|---|---|---|---|---|
| Elapsed | Formed on each Apple Slice | | | | |
| Time | (grams) | | | | |
| 0 min | 0 | 0 | 0 | 0 | 0 |
| 15 min | 0.257 | 0.239 | 0.253 | 0.258 | 0.254 |
| 30 min | 0.572 | 0.567 | 0.590 | 0.523 | 0.540 |
| 60 min | 0.801 | 0.752 | 0.712 | 0.743 | 0.722 |

TABLE 1B
Fuji Apples - 5 Slices Treated with Sucrose
10 mm Apple Slice

| | Cumulative Weight of Water | | | | |
|---|---|---|---|---|---|
| Elapsed | Formed on each Apple Slice | | | | |
| Time | (grams) | | | | |
| 0 min | 0 | 0 | 0 | 0 | 0 |
| 15 min | 0.240 | 0.248 | 0.251 | 0.249 | 0.247 |
| 30 min | 0.543 | 0.560 | 0.551 | 0.602 | 0.591 |
| 60 min | 0.767 | 0.793 | 0.759 | 0.811 | 0.781 |

TABLE 1C
Fuji Apples - 5 Slices Treated with Xylitol
5 mm Apple Slice

| | Cumulative Weight of Water | | | | |
|---|---|---|---|---|---|
| Elapsed | Formed on each Apple Slice | | | | |
| Time | (grams) | | | | |
| 0 min | 0 | 0 | 0 | 0 | 0 |
| 15 min | 0.491 | 0.504 | 0.532 | 0.603 | 0.594 |
| 30 min | 1.190 | 1.186 | 1.188 | 1.191 | 1.184 |
| 60 min | 1.244 | 1.298 | 1.301 | 1.286 | 1.276 |

TABLE 1D
Fuji Apples - 5 Slices Treated with Xylitol
10 mm Apple Slice

| | Cumulative Weight of Water | | | | |
|---|---|---|---|---|---|
| Elapsed | Formed on each Apple Slice | | | | |
| Time | (grams) | | | | |
| 0 min | 0 | 0 | 0 | 0 | 0 |
| 15 min | 0.548 | 0.539 | 0.557 | 0.568 | 0.593 |
| 30 min | 1.160 | 1.188 | 1.190 | 1.175 | 1.186 |
| 60 min | 1.248 | 1.277 | 1.260 | 1.268 | 1.304 |

### Example 2

Four apples of the “Granny Smith” variety were purchased from a local grocery store and kept refrigerated until use. The apples were of similar size and maturity. Apple slices were produced by cross-sectionally cutting the fruit without removing the skin, so that only the cut surfaces were available for the mass transport. Two experimental series identified by two numbers (initial slice thickness and osmotic agent utilized), and were carried out at 20 degrees C., with two different sample thicknesses of 5 mm and 10 mm The quantity of osmotic dewatering was measured for each slice, at elapsed time intervals of 0, 15, 30, and 60 minutes.

Apple slices were obtained by cross-sectionally cutting the fruit without removing the skin, so that only the cut surfaces were available for the mass transport. Two osmotic agents were used in the series, commercially available sucrose and xylitol. The osmotic agents were both milled to the same consistency, and applied directly to the cut surface in powder form. The slices were divided into series, each slice was weighed, and the osmotic agent in powder form was applied directly to the cut surface. Equal quantities of sucrose powder at 0.593 grams of the pure sucrose powder was applied to each slice for each sucrose series as listed in Tables 2A and 2B, and 0.593 grams of the pure xylitol powder was applied to each slice in each xylitol series as listed in Tables 2C and 2D. The system was maintained at the selected temperature for the duration.

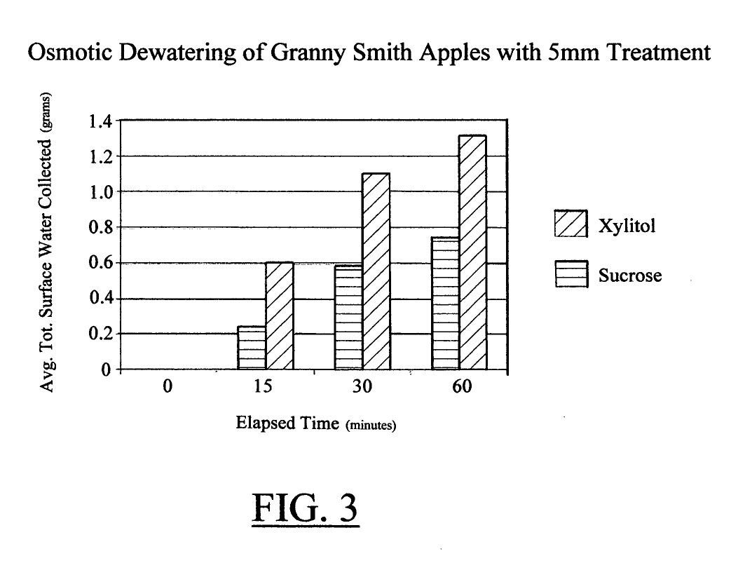

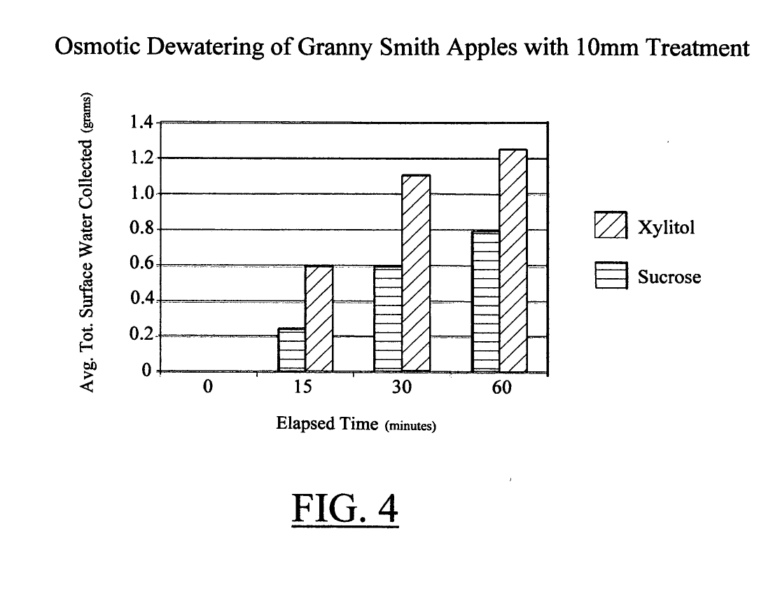

After the treatment, the surface water on each apple slice was collected and weighed, after which the slice was again weighed, with the accumulated weight of water collected tabulated below. The Granny Smith slices treated with xylitol produced up to 50% more water at the cut surface as measured by weight than the slices treated with sucrose in both the 5 mm and 10 mm slices. From the experiments, maximum dewatering appears to occur at approximately 30 minutes. Furthermore, the rate of dewatering appears to slow after 30 minutes, and reaches minimum incremental levels of further change at 60 minutes. Tables 2A through 2D shows the results of the experiment for Example 2, with the surface formed water on each slice collected and weighed at each time interval. The systems for each series were maintained at the selected temperature for the duration of the experiment. After the treatment, the surface water on each apple slice was collected and weighed, after which the slice was again weighed, with the accumulated weight of water collected tabulated below. Additionally, the results of Table 2A are correlated to the results of Table 2C in FIG. 3, and the results of Table 2B are correlated to the results of Table 2D in FIG. 4. From FIGS. 3 and 4, the unexpected advantage of xylitol as a dewatering agent over sucrose, for use with Granny Smith variety apples, is readily apparent.

TABLE 2A
Granny Smith Apples - 5 Slices Treated with Sucrose
5 mm Apple Slice

| | Cumulative Weight of Water | | | | |
|---|---|---|---|---|---|
| Elapsed | Formed on each Apple Slice | | | | |
| Time | (grams) | | | | |
| 0 min | 0 | 0 | 0 | 0 | 0 |
| 15 min | 0.244 | 0.245 | 0.239 | 0.255 | 0.229 |
| 30 min | 0.591 | 0.582 | 0.579 | 0.592 | 0.585 |
| 60 min | 0.799 | 0.755 | 0.721 | 0.734 | 0.725 |

TABLE 2B
Granny Smith Apples - 5 Slices Treated with Sucrose
10 mm Apple Slice

| | Cumulative Weight of Water | | | | |
|---|---|---|---|---|---|
| Elapsed | Formed on each Apple Slice | | | | |
| Time | (grams) | | | | |
| 0 min | 0 | 0 | 0 | 0 | 0 |
| 15 min | 0.241 | 0.259 | 0.239 | 0.248 | 0.242 |
| 30 min | 0.591 | 0.603 | 0.589 | 0.605 | 0.596 |
| 60 min | 0.776 | 0.802 | 0.795 | 0.812 | 0.793 |

TABLE 2C
Granny Smith Apples - 5 Slices Treated with Xylitol
5 mm Apple Slice

| | Cumulative Weight of Water | | | | |
|---|---|---|---|---|---|
| Elapsed | Formed on each Apple Slice | | | | |
| Time | (grams) | | | | |
| 0 min | 0 | 0 | 0 | 0 | 0 |
| 15 min | 0.605 | 0.623 | 0.592 | 0.611 | 0.599 |
| 30 min | 1.051 | 1.115 | 1.119 | 1.123 | 1.116 |
| 60 min | 1.424 | 1.289 | 1.310 | 1.268 | 1.277 |

TABLE 2D
Granny Smith Apples - 5 Slices Treated with Xylitol
10 mm Apple Slice

| | Cumulative Weight of Water | | | | |
|---|---|---|---|---|---|
| Elapsed | Formed on each Apple Slice | | | | |
| Time | (grams) | | | | |
| 0 min | 0 | 0 | 0 | 0 | 0 |
| 15 min | 0.592 | 0.623 | 0.627 | 0.566 | 0.590 |
| 30 min | 1.092 | 1.105 | 1.112 | 1.121 | 1.103 |
| 60 min | 1.252 | 1.272 | 1.182 | 1.266 | 1.299 |

With the above findings on the use of xylitol as an osmotic dewatering agent in Fuji and Granny Smith Apples, several other apple and pear varieties have been treated with xylitol, and with similar results. It is expected that all “pome” fruits will respond to the novel use of xylitol in a similar, remarkable fashion.

The present invention can be augmented, to heighten the “sensory characteristics” of the fresh cut pome fruits. These sensory characteristics primarily include flavor, but can also include color, smell, and taste components. It has been found that the osmotic dewatering aspects of xylitol lends to an unexpected and dramatic increase in the uptake, or infusion of additional, flavor enhancing solutes, herein termed “flavoring agents,” into the cut surface of the cut fruit, especially when applied to a freshly cut apple, along with the xylitol dewatering agent. A most preferred combination of flavoring agent and dewatering composition includes a powdered mixture of the xylitol and additionally an artificial, natural or organic flavoring agent. Optionally, citric acid, ascorbic acid, or an enzyme can be added for additional flavoring, anti-browning and preservative effects, and generally described herein as “preservative agents.”

Preferred flavors for use as the flavoring agent include: orange, vanilla, banana, caramel, black cherry, blackberry and grape. However, additional conventional flavorings are anticipated for use, such as: strawberry, lemon, lime, raspberry, apple, apple spice, boysenberry, citrus, bubble gum, pineapple, grapefruit, blueberry, watermelon, cranberry, peach, cherry, coconut, chocolate, cotton candy, toffee, gingerbread, peanut butter, pear, tangerine, watermelon, and any combinations thereof.

The combined dewatering, flavoring and preservative compound may be formulated, packaged and sold for application to the fresh-cut fruit after purchase, or the compound may be applied to a pre-cut fruit prior to purchase, preferably in a bulk package of the sliced fruit, and most preferably fresh-cut apples. In the treatment of the cut fruit in bulk, a process similar to that described above, for the treatment of bulk cut fruit with the osmotic agent alone can be utilized, along with the further step of applying the flavoring agent and optionally the preservative agent on a conventional industrial conveyor and processing system.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A method of osmotically dewatering a freshly cut apple piece comprising the steps of:
a) applying a xylitol to a cut surface portion of the apple piece;
b) exposing the cut surface portion of the apple piece to air for a curing period, to form a surface solution on the cut surface portion of the apple piece; and
c) removing excess surface solution from the cut surface portion of the apple piece.

2. The osmotic dewatering method according to claim 1, wherein the xylitol is a pure, powdered form of xylitol.

3. The osmotic dewatering method according to claim 1, wherein the xylitol is a pure, liquid form of xylitol.

4. The osmotic dewatering method according to claim 1, further comprising the step of:
d) applying a flavoring agent to the cut surface portion of the apple piece.

5. The osmotic dewatering method according to claim 1, further comprising the steps of:
d) applying a preservative agent to the cut surface portion of the apple piece.

6. The osmotic dewatering method according to claim 1, further comprising the step of:
d) wicking excess surface solution from the cut surface portion of the apple piece.

7. The osmotic dewatering method according to claim 1, further comprising the step of:
d) packaging the apple piece in a water tight container.

8. A method of osmotically dewatering a freshly cut pome fruit piece comprising the steps of:
a) treating a cut surface portion of the pome fruit piece with a pure a xylitol compound;
b) curing the cut surface portion of the pome fruit piece, to allow formation of a surface solution on the cut surface portion of the pome fruit piece; and
c) removing excess surface solution from the cut surface portion of the pome fruit piece.

9. The osmotic dewatering method according to claim 8, wherein the xylitol compound is a pure, powdered form of xylitol.

10. The osmotic dewatering method according to claim 8, wherein the xylitol compound is a pure, liquid form of xylitol.

11. The osmotic dewatering method according to claim 8, further comprising the steps of:
d) wicking excess surface solution from the cut surface portion of the pome fruit piece.

12. The osmotic dewatering method according to claim 8, further comprising the steps of:
d) packaging the pome fruit piece in a water tight container.

13. The osmotic dewatering method according to claim 8, further comprising the step of:
d) applying a flavoring agent to the cut surface portion of the pome fruit piece.

14. The osmotic dewatering method according to claim 8, further comprising the steps of:
d) applying a preservative agent to the cut surface portion of the pome fruit piece.

15. A method of osmotically dewatering and favoring a freshly cut apple piece comprising the steps of:
a) formulating a flavoring infusing and dewatering agent including
a) applying a combined flavoring agent, dewatering agent, and preservative agent to a cut surface portion of the apple piece;
b) exposing the cut surface portion of the apple piece to air for a curing period, to form a surface solution on the cut surface portion of the apple piece; and
c) removing excess surface solution from the cut surface portion of the apple piece.

16. The osmotic dewatering method according to claim 15, wherein the xylitol compound is a pure, powdered form of xylitol.

17. The osmotic dewatering method according to claim 15, wherein the xylitol compound is a pure, liquid form of xylitol.

18. The osmotic dewatering method according to claim 15, further comprising the steps of:
d) wicking excess surface solution from the cut surface portion of the apple piece.

19. The osmotic dewatering method according to claim 15, further comprising the steps of:
d) packaging the apple piece in a water tight container.
